(19) United States
(12) Patent Application Publication
(10) Pub. No.: US 2006/0045098 A1
(43) Pub. Date: Mar. 2, 2006

(54) System for port mapping in a network

(76) Inventor: Michael R. Krause, Boulder Creek, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/930,977

(22) Filed: Aug. 31, 2004

(51) Int. Cl. H04L 12/56

(52) U.S. Cl. 370/396

(57) ABSTRACT

A system for mapping a target service port, specified by an application, to an enhanced service port enabled for an application-transparent communication protocol, in a network including a plurality of endnodes, wherein at least one of the service ports within the endnodes includes a transparent protocol-capable device enabled for the application-transparent communication protocol. In operation, a port mapping request, initiated by the application, specifying the target service port and a target service accessible from the port, is received at one of the endnodes. A set of input parameters describing characteristics of the endnode on which the target service executes is accessed. Output data, based on the endnode characteristics, indicating the transparent protocol-capable device that can be used to access the target service, is then provided to thereby enable mapping of the target service port to the enhanced service port associated with the transparent protocol-capable device.

### BACKGROUND

Port mapping in a communications network may be defined as the translation of an application-specified target service port into an associated service port that can be addressed using protocols transparent to the application. A local application that wishes to communicate with a remote application needs to know how to address the remote application, and also needs to know the network address (e.g., an IP address) of the system on which the remote application is running. This is accomplished by specifying a service port, an N-bit identifier (a low-level protocol such as TCP uses a 16-bit number) that uniquely identifies an application running on the remote system.

The service port is the listen port used by an application (e.g., a sockets application) for connection establishment purposes in a network. The sockets interface is a de facto API (application programming interface) that is typically used to access TCP/IP networking services and create connections to processes running on other hosts. Sockets APIs allow applications to bind with ports and IP addresses on hosts.

However, port address space is generally limited to 16-bits per IP address, and for networking protocols that use RDMA (Remote Direct Memory Access), a socket application ‘listen’ operation requires two listen ports—one non-RDMA port for non-RDMA-capable clients, and one RDMA port for RDMA-capable. Therefore, the use of an RDMA-based protocol may consume limited port space (thus reducing the effective port space) due to the need to replicate non-RDMA and RDMA listen ports.

Additional problems related to the above-described type of system include the need for a port mapping mechanism to allow an application to discover an appropriate RDMA port, and also the need to determine the port-mapper service location, i.e., the port to target for performing a port mapping wire protocol exchange.

### SUMMARY

A system and method are disclosed for mapping a target service port, specified by an application, to an enhanced service port enabled for an application-transparent communication protocol, in a network including a plurality of endnodes, wherein at least one of the service ports within the endnodes includes a transparent protocol-capable device enabled for the application-transparent communication protocol.

In operation, a port mapping request, initiated by the application, specifying the target service port and a target service accessible from the port, is received at one of the endnodes. Next, a set of input parameters describing characteristics of the endnode on which the target service executes is accessed. Output data, based on the endnode characteristics, indicating the transparent protocol-capable device that can be used to access the target service, is then provided to thereby enable mapping of the target service port to the enhanced service port associated with the transparent protocol-capable device.

### BRIEF DESCRIPTION OF THE DRAWINGS

FIG. 1 is a diagram showing high-level architecture of a prior art network;

FIG. 2 is a diagram showing exemplary embodiment of a high-level architecture of the present port mapper system;

FIG. 3A is a diagram showing an exemplary sequence of exchanges between a port mapper service provider and a port mapper client, for implementing a port mapping operation;

FIG. 3B is a diagram showing an exemplary sequence of exchanges between a connecting peer and an accepting peer, for establishing a connection between the two peers;

FIG. 4 is a diagram showing an exemplary API calling sequence for performing address/port resolution and establishing a connection between connecting peer and an accepting peer;

FIG. 5 is a diagram showing an exemplary configuration for port mapping, using local policy management agents;

FIG. 6 is a diagram showing an exemplary configuration for port mapping, using a centralized policy management agent;

FIG. 7 is a diagram showing an exemplary implementation wherein port mapping is performed on behalf of a connecting peer by a local PM client and a local policy management agent;

FIG. 8 is a diagram showing an exemplary port mapping implementation wherein the connecting peer and accepting peer each use a local PM client/PMSP and local policy management agent;

FIG. 9 is a diagram showing an exemplary port mapping implementation wherein the PM client/PMSP are centrally managed;

FIG. 10 is a diagram showing an exemplary port mapping implementation wherein a specific AP IP target address for a given service is an aggregate address;

FIG. 11 is a diagram showing exemplary fields in a port mapper request message employed by the port mapper wire protocol;

FIG. 12 is a diagram showing an exemplary policy management scenario in which an outbound RNIC is selected;

FIG. 13 is a diagram showing an exemplary policy management scenario in which an inbound RNIC is selected;

FIG. 14 is a diagram showing an exemplary policy management scenario in which a single target IP address used to represent multiple RNICs;

FIG. 15 is a diagram showing an exemplary policy management scenario in which there are multiple RNICs on different endnodes;

FIG. 16 is a diagram showing an exemplary a set of policy management functions, F1 and F2, associated with each of the expected communicating endnodes;

FIG. 17 is a flowchart showing an exemplary set of high-level steps performed in processing a port mapping request; and

FIG. 18 is a flowchart showing an exemplary set of steps performed during step 1735 of FIG. 17.

### DETAILED DESCRIPTION

### DEFINITIONS

Endnode—Any class of device used to provide a service, e.g., a server, a client, a storage array, an appliance, a PDA, etc. Two endnodes communicate with one another via logical connections between ports at each endnode.
Port—A port names an end of a logical connection, and is the final portion of the destination address for a message sent on a network. In a TCP environment, for example, every packet sent over a network carries its own source and destination addresses. Connections, including TCP connections, are made from a particular port at one IP address to a particular port at another IP address. Thus, every TCP connection is uniquely identified by a 4-tuple: address1, port1, address2, port2, where each address is an IP address and each port is a 16 bit number.
Port Mapping—Application-transparent translation of an application-specified target service port into an associated RDMA-capable service port. A service port, in this document, is the listen port used by a Sockets application for connection establishment purposes.
Port Mapper Protocol—A wire protocol used to communicate port mapping information between a port mapping service provider and a client, which may be a PM client or a connecting peer.
Connecting Peer—(CP) The peer that sends a connection establishment request. When used in the context of the port mapper protocol, a connecting peer can also be a management agent acting on behalf of a connecting peer.
Accepting Peer—(AP) The peer that sends a reply to the connection establishment request during connection establishment.
PM Client—Implements the port mapper protocol on behalf of a connecting peer. A PM client may be co-located with a CP or distributed with respect to a plurality of potential CPs.
PMSP—Port mapping service provider. The management agent, associated with an accepting peer, responsible for implementing port mapping functionality. The PMSP returns the Sockets Direct Protocol (SDP) listen port and IP address (e.g., RDMA address), if any, that the connecting peer may use to establish an RDMA-based connection with the specified accepting peer.
Policy management agent—An entity, typically implemented in software, that executes policy management operations. The PMA implements port mapping policy, and works with the PMSP, for example, to perform the port mapping function.
   System Environment

The present system comprises related methods for port mapping in a communications network. In one embodiment, the present port mapping system operates in conjunction with a wire protocol that uses RDMA, such as Sockets Direct Protocol (SDP). Sockets Direct Protocol is used as an exemplary transport protocol in the examples set forth herein. SDP is a byte-stream transport protocol that provides SOCK_STREAM semantics over a lower layer protocol (LLP), such as TCP, using RDMA (remote direct memory access). SDP closely mimics TCP's stream semantics, and, in an exemplary embodiment of the present system, the lower layer protocol over which SDP operates is TCP. SDP allows existing sockets applications to gain the performance benefits of RDMA for data transfers without requiring any modifications to the application. Therefore, SDP can have lower CPU and memory bandwidth utilization as compared to conventional implementations of sockets over TCP, while preserving the familiar byte-stream oriented semantics upon which most current network applications depend. It should be noted that the present system is operable with transport layer protocols other than SDP and TCP, which protocols are used herein for exemplary purposes.

SDP operates transparently underneath SOCK_STREAM applications. SDP is intended to allow an application to advertise a service using its application-defined listen port and transparently connect using an SDP RDMA-capable listen port. However, if the SDP connecting peer does not know the port and IP address to use when creating a connection for SDP communication, it must resolve the TCP port and IP address used for traditional SOCK_STREAM communication to a TCP port and IP address that can be used for SDP/RDMA communication. Subsequent references in this document to ‘RDMA’ are intended to extend to the SDP protocol, as well as any other protocol that uses RDMA as a hardware transport mechanism.

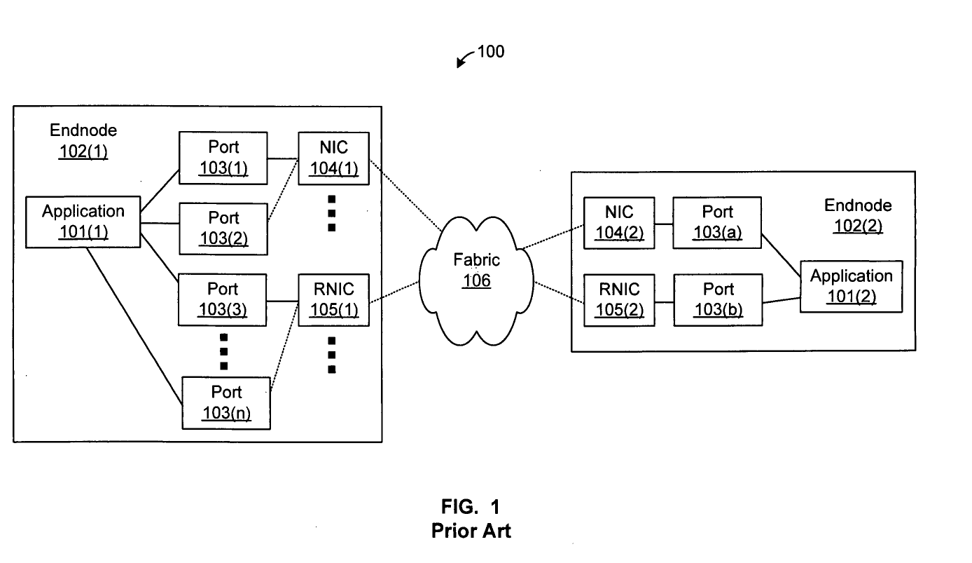

FIG. 1 is a diagram showing high-level architecture of a prior art network 100 which provides the operating environment for the present port mapping system. As shown in FIG. 1, applications 101(*), running on endnodes 102(*), communicate with their peer applications 101(*) via respective ports 103(*), network interface cards 104(*)/105(*), and fabric 106. As used herein, a ‘wild card’ indicator “(*)” following a reference number indicates an arbitrary one of a plurality of similar entities. An endnode 102(*) may use multiple ports 103(*) to connect to a fabric 105(*). For example, endnode 102(1) includes ports 103(1)-103(n), any of which may be connected to fabric 106 via a corresponding network interface card, which may be a NIC 104(*), RNIC 105(*), or any other device that implements communications between endnodes 102(*). An RNIC 105(*) is a NIC (network interface card) that supports RDMA (remote direct memory access) protocol. As used herein, ‘RNIC’ is a generic term and can be any type of interconnect that supports the RDMA protocol. For example, the interconnect implementation may be RDMA over TCP/IP, RDMA over SCTP, RDMA over InfiniBand, or RDMA over a proprietary protocol (e.g., I/O interconnect or backplane interconnect).

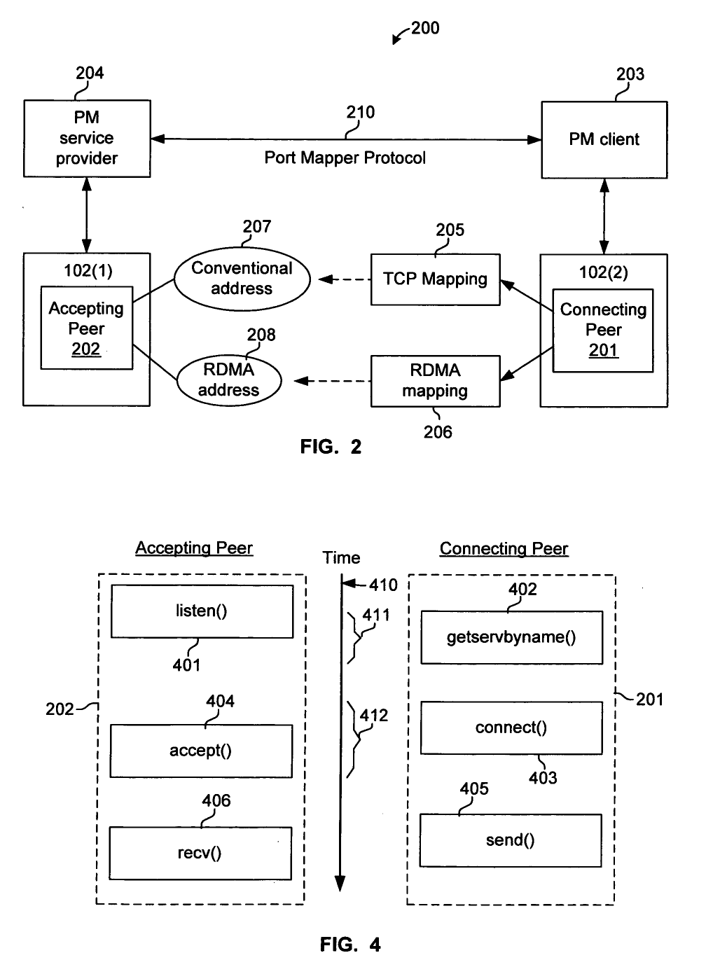

FIG. 2 is a diagram showing exemplary high-level architecture of the present port mapper system 200. As shown in FIG. 2, a port mapper service provider (PMSP) 204, functioning as a server, and a port mapper client (PM client) 203 communicate using a port mapper protocol 210, described in detail below. Port mapper protocol 210 enables a connecting peer to discover an RDMA Address given a conventional address. An RDMA address is a TCP port and IP address for the same target service, but the RDMA address requires data to be transferred using a RDMA-based protocol such as SDP over RDMA.

The accepting peer (AP) 202 and connecting peer (CP) 201 use the results from the port mapper protocol to initiate LLP (lower level protocol, e.g., TCP) connection setup. The port mapper protocol 210 described herein enables a connecting peer 201, through a port mapper client 203, to negotiate with port mapper service provider 204 to translate an application-specified target service port into an associated RDMA service port. Communication between a CP 201 and an AP 202 may be implemented over any fabric type, including backplane, switch, cable, or wireless.

The port mapper service provider 204 may be implemented using either a centralized agent (e.g., a central management agent acting on behalf of one or more PM clients 203, CP 201 or AP 202), or the PMSP 204 may be distributed. A PMSP 204 may include any additional management agent functionality used to implement the port mapper protocol 210. A PMSP 204 may be located anywhere within a network, including being co-located with a connecting peer 201 or an accepting peer 202. In one embodiment, the PMSP 204 may be merely a query service, thus requiring the CP 201 to implement the port mapper protocol 210 as required to establish communication with an AP 202.

In the example shown in FIG. 2, if connecting peer 201 does not know the port and IP address to use when creating a connection for RDMA communication with accepting peer 202, the conventional TCP port and IP address 207 provided by normal TCP mapping 205 (and used, e.g., for traditional SOCK_STREAM communication) must be resolved, via RDMA mapping 206 to a TCP port and IP address (RDMA address) 208 that can be used for RDMA communication.

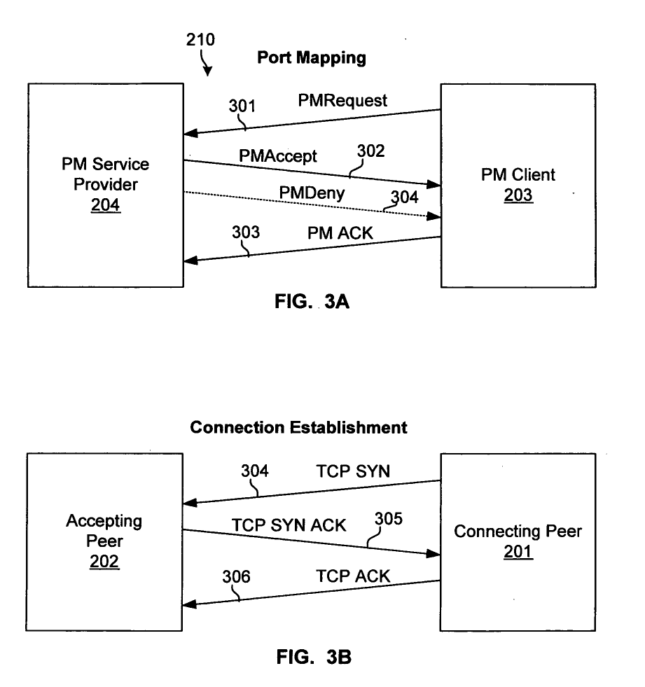

FIG. 3A is a diagram showing an exemplary sequence of exchanges between a port mapper service provider (PMSP) 204 and a port mapper client 203, for implementing a port mapping operation. Setting up an RDMA connection is done in two stages, with the first stage comprising a three-way message exchange. In an exemplary embodiment, the three-way exchange uses the port mapper protocol 210, described in detail below. From the client's perspective, the first stage of RDMA connection set-up is performed by the PM client 203 to discover the address (either the RDMA address 208 or the conventional address 207) to be used for lower level protocol (LLP) connection setup between CP 201 and AP 202.

As shown in FIG. 3A, a port mapper request message (PMRequest) 301 is initially sent from PM client 203 to PMSP 204 to request the PMSP to provide a port mapping function based on the service port 103(*), connecting peer IP address, and the accepting peer IP address. In response, PMSP 204 sends a port mapper response message (PMAccept) 302 to the PM client 203. Alternatively, a PMDeny message 304 may be sent by PMSP 204 to indicate that the port mapping operation was denied, i.e., the operation could not be executed.

The PMAccept message 302 is used by the PMSP 204 to return the mapped port, the connecting peer IP address to be used, the accepting peer IP address to be used, and a time value indicating how long the mapping will remain valid.

PM client 203 then sends a port mapper acknowledgement message (PM ACK) 303 to confirm the receipt of the response message. Failure to return an acknowledgement message within time value returned in the response message may result in the mapping being invalidated and the associated resources being released.

The second stage of setting up a connection occurs when the connecting peer 201 attempts to establish a connection to a particular service running on AP 202 using the address negotiated in the first stage. In the second stage of connection setup, connecting peer 201, using the results of the port mapper protocol message exchange of FIG. 3A, attempts to setup a LLP (e.g., TCP) connection to the accepting peer's RDMA address, which will cause RDMA connection setup to be initiated, or the CP 201 will attempt to setup an LLP connection to the conventional address, which will cause traditional streaming mode communication to be used.

FIG. 3B is a diagram showing an exemplary sequence of exchanges between a connecting peer 201 and an accepting peer 202, for establishing a connection between the two peers. The LLP used in the FIG. 3B example is TCP. As shown in FIG. 3B, connecting peer 201 initiates a TCP connection by sending a TCP SYN message to accepting peer 202, using the RDMA address provided by the port mapping process described in FIG. 3A. In response, accepting peer 202 replies with a TCP SYN ACK 305. Connecting peer 201 then responds by sending a TCP ACK 306 to accepting peer 202 to establish the TCP connection between CP 201 and AP 202.

FIG. 4 is a diagram showing an exemplary API calling sequence for performing address/port resolution and establishing a connection between a connecting peer 201 and an accepting peer 202. As shown in FIG. 4, at time 410, accepting peer 202 creates a listen port 103(*) by issuing a listen( ) call 401. Service resolution is then initiated by a getservbyname( ) call 402 issued by connecting peer 201, and proceeds during time interval 411. During the connection phase 412, CP 201 and AP 202 exchange connect( ) and accept( ) calls 403/404, after which communication between the CP and the AP is conducted by exchanging send( ) and receive( ) calls 405/406.

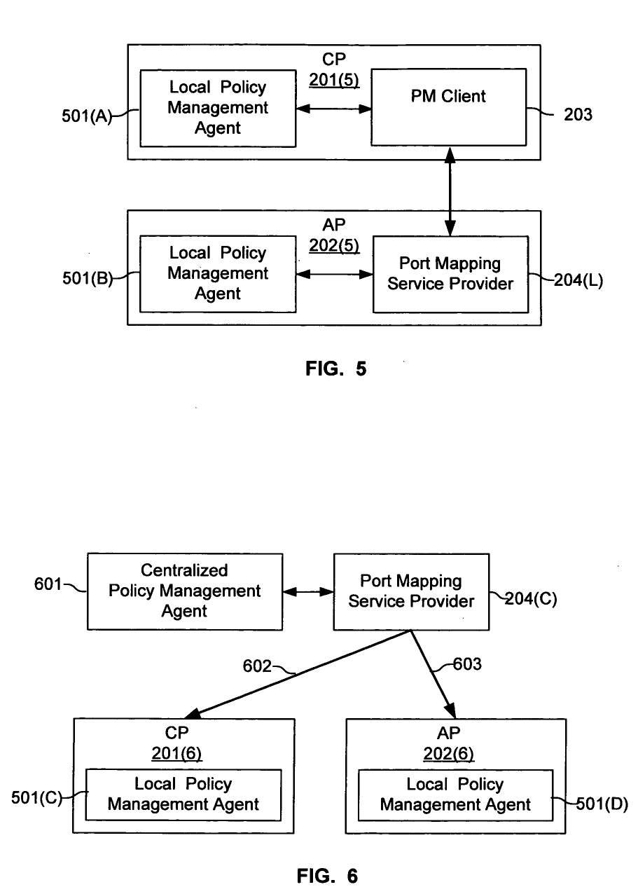

In the API calling sequence shown in FIG. 4, port mapper service may be transparently invoked either during service resolution (e.g., by a getservbyname( ) request) or during the connect processing (e.g., via a connect( ) request), during time interval 411 or 412, respectively. The accepting peer 202 may create the listen port for the corresponding service at listen( ) time or it may dynamically create the listen port in response to a port mapper request message being received. Either the connecting peer 201 or the accepting peer 202 may interact with central or local policy management agents prior to or as part of their interaction with the port mapping service being used. The AP 202 may implement dynamic listen port creation and require the CP 201 or an agent 501(*) (as shown on FIG. 5) acting on its behalf to query every time, every N units of time, or to use a permanently or temporarily cached mapping result.

Policy Management Agent Configuration

FIG. 5 is a diagram showing an exemplary configuration for port mapping, using local policy management agents 501(A) and 501(B), and FIG. 6 is a diagram showing an exemplary port mapping configuration, using a centralized policy management agent 601. In FIGS. 5 and 6, local policy management agents 501(*) implement port mapping policy and work with a PMSP 204(*), for example, to perform the port mapping function.

As shown in FIG. 5, the port mapping service provider (PMSP) may be distributed, being co-located with each AP 202, as indicated by PMSP 204(L), which is co-located with AP 202(5). In the configuration of FIG. 5, port mapping information is communicated directly between CP 201(5) and AP 202(5).

Alternatively, the port mapping service provider may be centralized, as indicated in FIG. 6, where centralized PMSP 204(C) is shown using a centralized policy management agent 601. Centralized policy management agent 601 may act on behalf of one or more PM clients 203 (not shown in FIG. 6), connecting peers 201(6) or accepting peers 202(6), as indicated by arrows 603/603.

A PMSP 204(*), PM client 203, CP 210, or AP 202 may interact with a central or co-located policy management agent 601/501 to implement endnode or service-specific policies, such as load-balancing (e.g., service based, hardware resource-based, endnode service capacity-based), redirection, etc.

An application, running on a connecting peer 201, that has a priori knowledge of an AP RDMA service listen port can target that listen port without requiring interaction with the PMSP. Such an application may still interact with a policy management entity to obtain the preferred CP and AP RNIC address. For example, if there are multiple RNICs 105(*) available on either a CP 201 or an AP 202, policy management interactions (described below in detail) are used to determine which RNIC 105(*) to target for communication purposes.

Port Mapping System Configuration

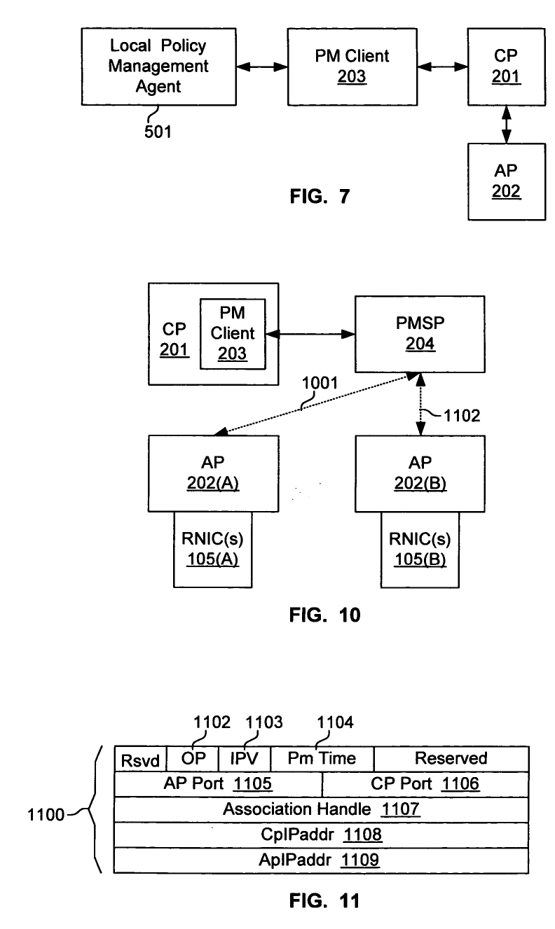

FIG. 7 is a diagram showing an exemplary implementation wherein port mapping is performed on behalf of a connecting peer 101 by a local PM client 203 and a local policy management agent 501. In the configuration shown in FIG. 7, connecting peer 201 contacts its local PM client 203, and requests the PM client to map the service port for the target AP 202. If PM client 203 has a valid cached mapping, it may return this immediately to the CP 201. If PM client 203 does not have a valid cached mapping, or if there are local policies to be validated prior to performing the mapping service, the PM client may contact the local policy management agent 501 to obtain the necessary port mapping information.

The PM client 203 may consult a system-local policy management agent [e.g., local PMA 501(A)] or a centrally managed policy management agent 601 (as shown in FIG. 6)) to determine an optimal response. If a valid port mapping is returned by the policy management agent 501/601, the CP 201 may proceed directly to connection establishment with the AP 202.

The accepting peer 202 may be co-located with the CP 201 (e.g., via loop-back communication) or the AP 202 may be remote. As used herein, the term ‘remote’ indicates a separate endnode target that is logically or physically distinct from the CP 201. Communication between the AP and the Cp may cross an endnode backplane or may cross an I/O-based fabric (wired or wireless).

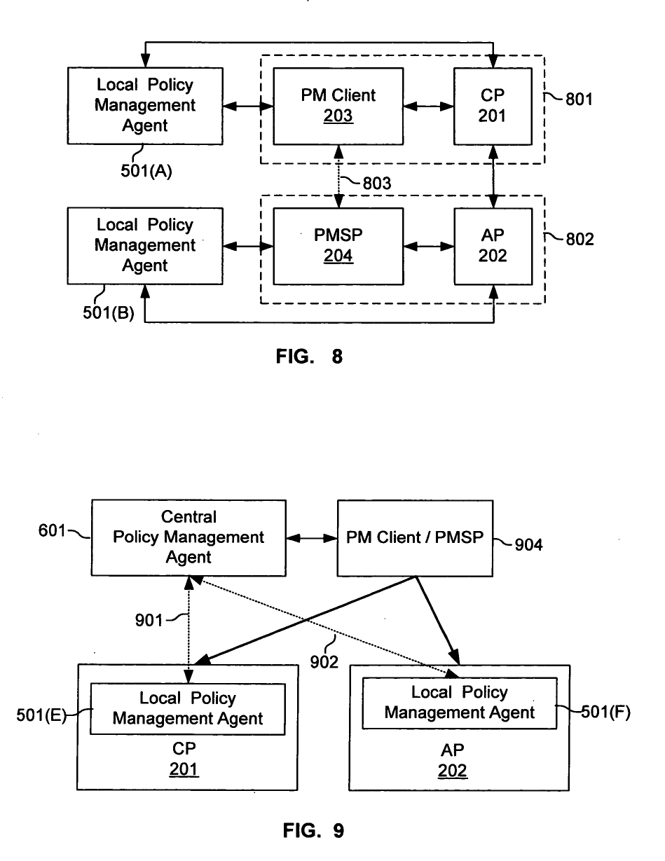

FIG. 8 is a diagram showing an exemplary port mapping configuration wherein the connecting peer 201 and accepting peer 202 each use a local policy management agent 501(8a)/501(8b), and a local PM client 203/PMSP 204, respectively. As shown in FIG. 8, CP 201 may be co-located with PM client 203, and PMSP 204 may be co-located with AP 202, as respectively indicated by dotted boxes 801 and 802. In the configuration of FIG. 8, CP 201 and AP 202 may consult with their respective PM client/local PMSP and/or consult the local policy management agent directly. In the case where CP 201 and AP 202 use their local PM client 203/PMSP 204, the CP and AP implement the port mapper protocol and the connection establishment protocol to the mapped port.

Alternatively, the connecting peer 201 and accepting peer 202 may use their respective PM client 203/PMSP 204 to proxy the port mapper protocol on their behalf. In this case, communication between the PM client 203 and the PMSP 204 (indicated by dotted arrow 803) uses a three-way UDP/IP datagram handshake, in an exemplary embodiment. Communication between the PM client 203 and the PMSP 204 may take place over any path; this communication is not required to occur via the actual hardware used for communication between the CP and the AP.

FIG. 9 is a diagram showing an exemplary port mapping configuration wherein a PM client or PMSP 904 is centrally managed. In an exemplary embodiment, multiple PM client/PMSP instances 904 may be distributed within a fabric. As indicated by arrows 901 and 902 in FIG. 9, central policy management agent 601 may communicate directly with CP/AP local policy management agents 501(E)/501(F) to discover local port mapping policies specific to an endnode 102(*) including a CP 201 or AP 202. During the port mapping policy discovery process, the central policy management agent 601 determines the endnode's associated hardware, fabric connectivity, system usage models, service priorities, etc., so that the central policy management agent 601 can accurately respond to PMSP requests. For example, AP 202 updates the central PMSP 904 when a new service is supported and local policy indicates it should be used for RDMA, where resources (system, RNICs, etc.) are capable of providing support.

When connecting peer 201 issues a port map request message directly to PM client 904, the PM client either responds immediately (based on a priori knowledge), or the PM client 904 may consult with AP 202 and/or its local policy management agent 501(F) to generate a response.

FIG. 10 is a diagram showing an exemplary port mapping implementation wherein a specific AP IP target address for a given service is an aggregate address. As shown in FIG. 10, a PM client 203 may target a specific AP IP address for a given service, including a specific accepting peer IP address indicating a single RNIC; and also may target a specific AP IP address indicating one of multiple RNICs 105(*) on one or more endnodes 102. In the latter situation, the AP IP address aggregates multiple RNICs 105(*), and IP address resolution to an AP RNIC port must be unique to avoid packet misroutes. For example, AP 202(A) and AP 202(B) may have multiple RNICs in respective groups 105(A) and 105(B), and each RNIC group, or a subset thereof, may have a single, aggregate IP address,

As a result of a port mapper protocol exchange with PMSP 204, a PM client 203 may receive a ‘revised’ AP IP address from PMSP 204 that is different from the one initially selected by the PM client. In the FIG. 10 example, PM client 203, using PMSP 204, initially selects one or more RNICs 105(A) on accepting peer 202(A), as indicated by arrow 1001. However, either AP 202(A) or its policy management agent (not shown) may return an IP address that is different from the IP address selected by PN client 203. In such a case, the PM client 203 accepts the revised IP address returned in a PMAccept message 302, and directs subsequent RDMA transmissions to the target accepting peer 202 at the revised IP address.

Acceptance of an IP address that is different from the address initially selected allows an AP 202 or a policy management agent 501 acting on the AP's behalf to select the appropriate RNIC 105(*) for the desired service. The selected RNIC may be on the same endnode or redirected to a separate endnode. RNIC selection policies may be based on system load balancing algorithms or system quality of service (QoS) parameters for optimal service delivery, as described in detail below.

Port Mapper Protocol

As previously described with respect to FIG. 3A, in an exemplary embodiment, the port mapper wire protocol 210 uses a three-way UDP/IP (datagram) message exchange between the PM client 203 and the port mapper service provider (PMSP) 204 acting on behalf of the accepting peer 202, or the accepting peer itself. FIG. 11 is a diagram showing exemplary common fields in each port mapper message transmitted via the port mapper protocol 210. The following fields are shown in FIG. 11:
OP field 1102 is a 2-bit operation code used to identify the port mapper message type.
IPV field 1103 indicates the type of IP address being used. IPV=0×4 indicates an IPv4 address is used, and only the first 32-bits of the CpIPaddr and the ApIPaddr fields are valid; IPV=0×6 indicates an IPv6 address is used, i.e., all 128-bits of the CpIPaddr and the ApIPaddr fields are valid.
PmTime field 1104 is used in the port mapper accept message to indicate the total time, since a response message was generated, that the AP Port field (OP=1) is considered valid.
AP Port field 1105 is used to either request an associated port or return a mapped port.
CP Port field 1106 indicates the TCP port for the CP.
AssocHandle (association handle) field 1107 is used by the connecting peer to uniquely identify a port mapper transaction.
CpIPaddr field 1108 contains the CP IP address to be used for RDMA/SDP session establishment. The CpIPaddr may be different than the IP address used in the UDP/IP datagram header to transmit the message.
ApIPaddr field 1109 contains the AP IP address to be used for the RDMA/SDP session establishment. The ApIPaddr may be different than the IP address used in the UDP/IP datagram header to transmit the message.

The first message transmitted in the three-way UDP/IP message exchange between a PM client 203 and the PMSP 204/AP 202 is a PMReq message 301 (shown in FIG. 3A). This message is sent by the PM client 203 to the PMSP (or AP) to request an RDMA listen port for the corresponding service port

The PMReq message fields are set by the PM client as follows:
OP field 1102—set to a value of 0.
IPV field 1103—set to either 0×4 if the CpIPAddr and ApIPAddr are an IPv4 address or 0×6 if the CpIPAddr and ApIPAddr are IPv6 addresses.
PmTime field 1104—set to zero and ignored on receive.
AP Port field 1105—set to the listen port for the associated service.
CP Port field 1106—set to the local TCP Port number that the connecting peer will use when connecting to the service.
AssocHandle field 1107—set by the connecting peer to a unique value to differentiate in-flight transactions.
CpIPaddr field 1108—set to the connecting peer's IP address that will initiate LLP connection establishment.
ApIPaddr field 1109—set to the target accepting peer's IP address to be used in connection establishment.

A port mapper request (PMReq) message 301 is transmitted by the PM client 203 using UDP/IP to target the port mapper service provider port 103(*). If the port mapping operation is successful, the PMSP 204/AP 202 returns a PMAccept message 302. The PMAccept message 302 is encapsulated within UDP using the UDP Ports and IP Address information contained within the corresponding fields of the PMRequest message 301.

A port mapper accept (PMAccept) message 302 is sent by the PMSP 204/AP 202 in response to a port mapper request message 301.

The PMAccept message fields are set by the PMSP/AP as follows:
OP field 1102—set to a value of 01.
IPV field 1103—set to the same value as the IPV field in the PMReq message.
PmTime field 1104—set to indicate the total time, since a response message was generated, that the AP Port field (OP=1) is considered valid.
AP Port field 1105—set to the RDMA listen port.
CP Port field 1106—set to the same value as the CpPort field in the corresponding PMReq message.
AssocHandle field 1107—set to the same value as the AssocHandle field in the corresponding PMReq message.
CpIPaddr field 1108—set to the same value as the CpIPAddr field in the corresponding PMReq message.
ApIPaddr field 1109—set to the accepting peer's IP address to be used in connection establishment. The accepting peer may return a different ApIPAddr than requested in the corresponding PMReq message.

A PMAccept message 302 is transmitted using the address information contained in the UDP/IP headers used to deliver the corresponding PMReq message 301.

Upon receipt of a PMAccept message 302, the PM client 203 returns a port mapper acknowledgement (PMAck) message 303. The PMAck message 303 is encapsulated within UDP using the UDP Ports and IP Address information contained within the corresponding PMAccept message. The PMAck message fields are set by the PM client as follows:
OP field 1102—set to a value of 02.
IPV field 1103—set to the same value as the IPV field in the corresponding PMAccept message.
PmTime field 1104—set to zero and ignored on receive.
AP Port field 1105—set to the same value as the ApPort field in the corresponding PMAccept message.
CP Port field 1106—set to the same value as the CpPort field in the corresponding PMAccept message.
AssocHandle field 1107—set to the same value as the AssocHandle field in the corresponding PMAccept message.
CpIPaddr field 1108—set to the same value as the CpIPAddr field in the corresponding PMAccept message. An accepting peer implementation may use the CpIPAddr to validate the subsequent LLP connection request through association of the CpIPAddr with the ApPort returned in the corresponding PMAccept message.
ApIPaddr field 1109—set to the same value as the ApIPAddr field in the corresponding PMAccept message.

A PMAck message 303 is transmitted by the PM client using the address information contained in the UDP/IP headers used to deliver the PMAccept message.

The three-way message exchange of FIG. 3A supports either centralized or distributed (peer-to-peer) port mapper implementations while minimizing the number of packets exchanged between the connecting peer 2021 and the accepting peer 202. The flexibility afforded by the port mapper messages enables a variety of interoperable implementation options. For example, a PM client 203 may be implemented as an agent acting on behalf of the connecting peer 201 or be implemented as part of the connecting peer. A port mapping service provider 204 may also be implemented as an agent acting on behalf of the accepting peer 202 or be implemented as part of the accepting peer. In addition, the ApIPAddr field 1109 within the PMAccept message 302 may be different than the requested IP Address (i.e., the ApIPAddr field 1109 in the PMRequest 301) due to local policy decisions.

For example, if an accepting peer 202 contains multiple network interfaces, and its local policy supports network interface load balancing, then the accepting peer 202 may return a different ApIPAddr 1109 for the selected target interface than was requested in the PMReq message, as previously indicated with respect to FIG. 10. Acknowledgement messages should be returned to the source address contained in the UDP/IP datagram used to transmit the response. The corresponding CP 201 or agent acting on behalf of the CP must only use the information within the response message and not the information in the original request message as the PMSP 204 may have redirected the request to another endnode to generate an appropriate response.

A three-way message exchange allows an accepting peer 202 to dynamically create an RDMA listen port with knowledge that the connecting peer will utilize this port only within the time period specified in the PmTime field 1104. The accepting peer 202 may release the associated resources upon the time period expiring, if a PMAck message is not received. The ability to release resources minimizes the impact of a denial of service attack via consumption of an RDMA listen port.

If the port mapping operation is not successful, the accepting peer returns a PMDeny message 304. The PMDeny message 304 is encapsulated within UDP using the UDP Port and IP Address information contained within the corresponding PMRequest message. The PMDeny message fields are set by the accepting peer as follows:
OP field 1102—set to a value of 03.
IPV field 1103—set to the same value as the IPV field in the PMReq message.
PmTime field 1104—set to zero and ignored on receive.
ApPort field 1105—set to the same value as the ApPort field in the corresponding PMReq message.
CpPort field 1106—set to the same value as the CpPort field in the corresponding PMReq message.
AssocHandle field 1107—set to the same value as the AssocHandle field in the corresponding PMReq message.
CpIPAddr field 1108—set to the same value as the CpIPAddr field in the corresponding PMReq message.
ApIPAddr field 1109—set to the same value as the ApIPAddr field in the corresponding PMReq message.

A PMDeny message is transmitted using the address information contained in the UDP/IP headers used to deliver the PMReq message 301. Upon receipt of a PMDeny message 304, the PM client treats the associated port mapper transaction as complete and does not issue a PMAck message. A port mapper operation may fail for a variety of reasons, for example, no such service mapping exists, exhaustion of resources, etc.

PM Client Behavior

The combination of the PM client 203 and the connecting peer 201 select the combination of the AssocHandle 1107, CpIPAddr 1108, and CpPort 1106 in port mapper messages to ensure that the combination is unique within the maximum lifetime of a packet on the network. This ensures that the PMSP 204 will not see delayed duplicate messages. The PM client 203 arms a timer when transmitting a PMReq message 301. If a timeout occurs for the reply to the PMReq message (i.e., neither a corresponding PMAccept 302 nor a PMDeny 304 message was received before the timeout occurred), the PM client 203 then retransmits the PMReq message 301 and re-arms the timeout, up to a maximum number of retransmissions (due to timeouts).

The PM client 203 uses the same AssocHandle 1107, ApPort 1105, ApIPAddr 1109, CpPort 1106, and CpIPAddr 1108 on any retransmissions of PMReq 301. In an exemplary embodiment, the initial AssocHandle 1107 chosen by a host may be chosen at random to make it harder for a third party to interfere with the protocol 310. The combination of the AssocHandle, ApPort, CpPort, ApIPAddr, and CpIPAddr is unique within the host associated with the connecting peer 201. This enables the PMSP 204 to differentiate between client requests.

If the PM client 203 does not receive an answer from the PMSP 204 after the maximum number of timeouts, the PM client stops attempting to connect to an RDMA address and instead uses the conventional address for LLP connection setup. Conventional LLP connection setup will cause streaming mode data transfer to be initiated.

If the PM client 203 receives a LLP connection reset (e.g., TCP RST segment) when attempting to connect to the RDMA address, the PM client views this as equivalent to receiving a PMDeny message 304, and thus attempts to connect to the service using the conventional address.

If the PM client 203 receives a reply to a PMReq message 301, and later receives another reply for the same request, the PM client discards any additional replies (PMAccept or PMDeny) to the request.

If the PM client receives a PMAccept 302 or PMDeny 304 and has no associated state corresponding to receipt of the message, the message is discarded.

PM Server Behavior

The PMSP 204 may arm a timer when it sends a PMAccept message 302, to be disabled when either a PMAck 303 or LLP connection setup request (e.g., TCP SYN) to the RDMA address has occurred. If a PMAck message 303 or LLP connection setup request is not received before the end of the timeout interval, all resources associated with the PMReq 301 are then deleted. This procedure protects against certain denial-of-service attacks.

If the PMSP 204 detects a duplicate PMReq message 301, it replies with either a PMAccept 302 or a PMDeny 304 message. In addition, if the PMSP armed a timer when it sent the previous PMAccept message for the duplicated PMReq message, it resets the timer when resending the PMAccept message.

When the PMSP 204 is attempting to attach the connecting peer 201 to a service, the service can have one of two states—available or unavailable. If a PMSP receives a duplicate PMReq message 301, the PMSP may use the most recent state of the requested service to reply to the PMReq (either with a PMAccept 302 or a PMDeny 304).

The conventions noted above will cause the PMSP 204 to attempt to communicate the most current state information about the requested service. However, because the port mapper protocol 210 is mapped onto UDP/IP, it is possible that messages can be re-ordered upon reception. Therefore, when the PMSP receives a duplicate PMReq message 301, and the PMSP changes its reply from a PMAccept to a PMDeny or a PMDeny to a PMAccept, the reply can be received out-of-order. In this case the PM client 203 uses the first reply it receives from the PMSP.

If the PMSP 204 receives a PMReq 301 for a transaction that it has already sent back a PMAccept 302, but the AssocHandle 1107 does not match the prior request, the PMSP discards and cleans up the state associated with the prior request and process the new PMReq normally. Note that if a duplicate message arrives after the PMSP state for the request has been deleted, the PMSP will view it as a new request, and generate a reply. If the prior reply was acted upon by the connecting peer 201, then the latest reply should have no matching context and is thus discarded by the PM client 203.

Port Mapping Policy Management

In the present port mapping system, policy management is governed by rules that define how a given event is to be handled. For example, policy management may be used to determine the optimal RNIC 105 for either the CP 201 or the AP 202 to use for a given service. The RNIC thus determined may be one of multiple RNICs on a given endnode 102, or the RNIC may be on a separate endnode. In an exemplary embodiment, a PMA and PMSP/PM client exchange information via a two-way exchange-request-response communication where the PMSP/PM client requests information concerning which port to map and the IP address used to identify the RNIC. A PMA 501(*) may return one-shot information, or may return information indicating that the PMSP may cache a set of resources for a period of time.

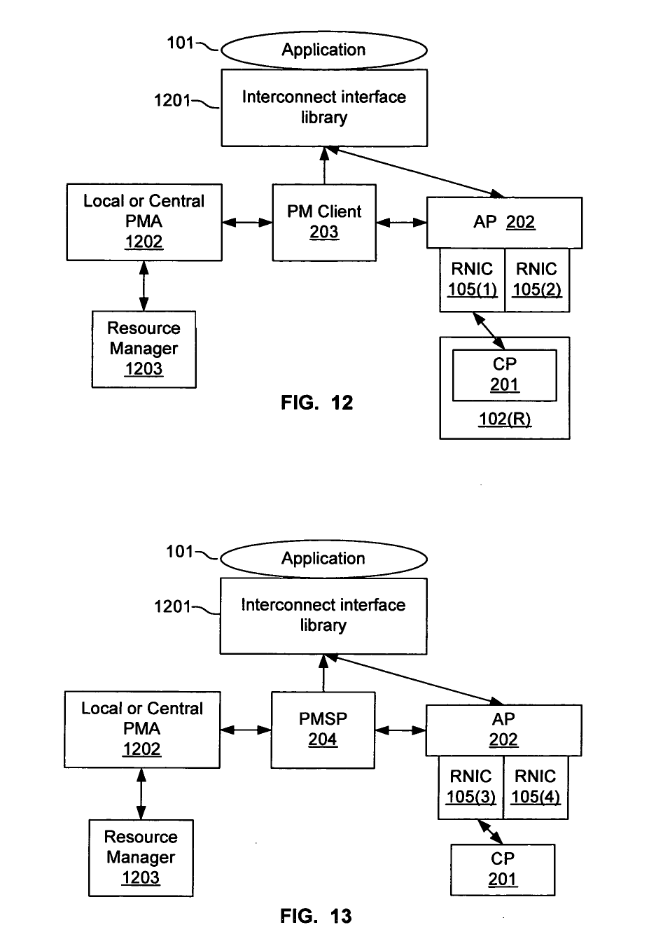

FIGS. 12-15 illustrate exemplary models that may be used for implementing various aspects of port mapping policy. FIG. 12 is a diagram showing an exemplary port mapping policy management scenario in which an outbound RNIC 105(1) is selected. As shown in FIG. 12, CP 201 may contain two or more RNICs 105(*). The target service and remote endnode 102(R) is identified from information derived during service resolution, for example, by a getservbyname( ) request) or during the connect processing (e.g., via a connect( ) request from a connect( ) call, as previously indicated.

The local PM client 203 may access the interconnect interface library 1201 (which is a Sockets library, in an exemplary embodiment), to determine if there is a valid port mapping. As used herein, ‘Sockets library’ is a generic term for a mechanism used by an application to access the Sockets infrastructure. While the present description is directed toward Sockets implementations, explicit or transparent access (as shown in FIG. 12) may apply to other interconnect interface libraries, such as a message passing interface.

PM client 203 may consult a local or centralized policy management agent (PMA) 1202 to determine if application 101 should be accelerated using an RDMA port, and also to identify a target outbound RNIC, e.g., RNIC 105(1). PMA 1202 may work with a resource manager 1203 to determine application-specific resource requirements and limitations, and may examine the remote endnode IP address to determine if any of the RNICs associated with CP 201 can reach this endnode 102(R). PMA 1202 may also access resource manager 1203, which provides application-specific policy management, to determine whether a selected RNIC 105(1) has available resources, and whether the associated application 101 should be off-loaded.

In addition, PMA 1202 may access routing tables (either local or remote [not shown]) to select an RNIC 105(*). Selection of a suitable RNIC 105(*) may be based on various criteria, for example, load-balancing, RNIC attributes and resources, QoS (quality of service) segregation, etc. For example, RNIC 105(1) may handle high-priority traffic while RNIC 105(2) handles traffic on a best-effort basis.

Policy Management Criteria

Exemplary policy management criteria include the following:
Examination of the target service: Services vary in the number that can be supported per endnode. The target service workload should be combined with current endnode workload and determine whether a new RDMA session should be established. Service may be considered as a function of the associated user, e.g., QoS/service level objective-based policy as a function of user attributes such as service billing, amount of access relative to other activities in the endnode(s) and fabric for fairness purposes, etc. The application's processor set (subset of the available computation elements, including processors, that an application is executed upon) may be assigned a subset of RNIC/resources as well as QoS—selection of service (number and type), target RNIC, etc. This may be optimized for a given processor set to improve access within the system itself.
Examination of the CP for a given service: The number of accelerated sessions for a given CP may be limited per service or aggregation of services or in combination with service user and transaction type being performed by the user (e.g., browsing vs. a transactional service).
Examination of the AP: Sufficient resources must be available for a particular AP. There may be multiple target AP that can provide the service; one of many endnodes may be capable of providing the associated service, which may be across any number of RNICs. If RNICs are coherent with one another, then the RNICs may be treated as an aggregation group.

FIG. 13 is a diagram showing an exemplary port mapping policy management scenario in which an inbound RNIC 105(*) is selected. As shown in FIG. 13, AP 202 may contain 2 or more RNICs 105(*). When PMSP 204 receives a port mapper request initiated by CP 201, if the received ApIPaddr 1109 is a one-to-one match with a specific AP RNIC, for example, RNIC 105(3), then the AP 202 hardware may be considered to be identified. If the received ApIPaddr 1109 has a one-to-N correspondence with N accepting peer RNICs 105(*), then policy local to AP 202 determines which RNIC 105(*) to select. In either case, PMSP 204 may contact PMA 1202 to determine if the service should be accelerated or not, using a variety of criteria. These local policy criteria may include, for example, the available RNIC attributes/resources, service QoS requirements, and AP endnode operational load and the impact of the particular service on the endnode load, as described in detail below.

After PMA 1202 determines what criteria are available for local policy decisions, PMSP 204 informs the PMA of the service that is being initiated to determine whether it should be accelerated or not. If it is to be accelerated, then the PMSP 204 identifies the hardware (via an IP address which logically identifies the RNIC) as well as the mapped port (an RDMA listen port) for return in the PMAccept message. When PMSP 204 identifies the appropriate hardware for a given service, it may cache this information and reserve a number of sessions (the number of sessions that are established or reserved may be tracked by PMA 1202). When the PMSP 204 identifies the hardware, it can also identify all of the associated resources for that hardware as well as the executing node to enable the subsequent connection request (e.g., TCP SYN) to be processed quickly. These hardware-associated resources include connection context, memory mappings, scheduling ring for QoS purposes, etc. If the PMSP 204 has cached or reserved resources, it can avoid interacting with PMA 1202 on every new port map request and simply work out of its cache to complete a mapping request.

PMA 1202 may work with AP 202 to reserve resources for subsequent RDMA session establishment. PMSP 204 returns a PMAccept 302 message with the appropriate ApIPaddr 1109 and service port 103(*), indicated in AP Port field 1105, if the port mapping operation is successful.

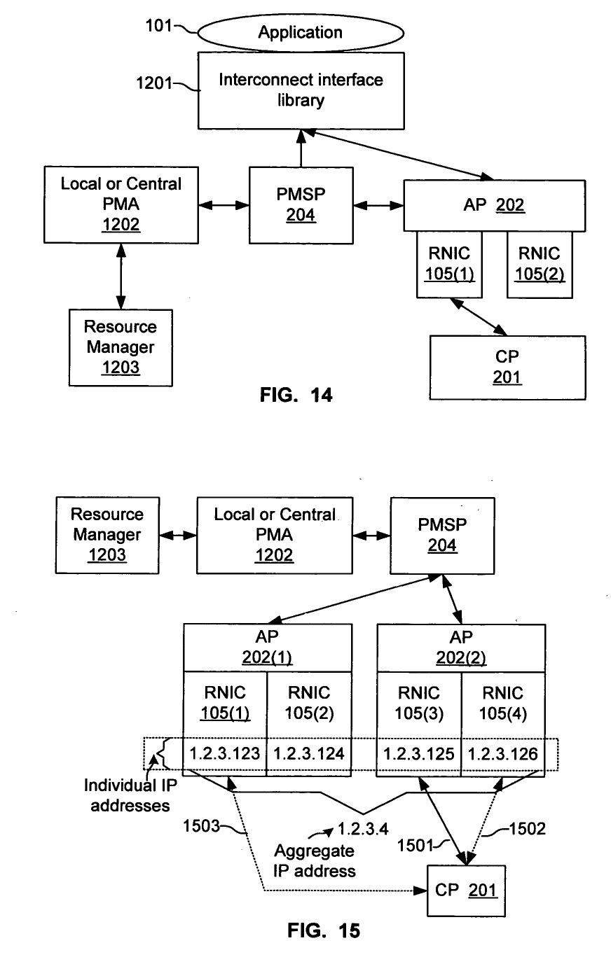

FIG. 14 is a diagram showing an exemplary port mapping policy management scenario in which a single target IP address used to represent multiple RNICs 105(*). In FIG. 14, connecting peer 201 (or the PM client 203 for the CP 201) targets a unique AP IP port mapping address on AP 202. A centralized PMSP 204 (or a PMSP local to AP 202) receives the port mapping request and queries local or central PMA 1202 to determine local policy regarding whether to accelerate application 101 and, if so, which RNIC 105(*) should be used. PMA 1202 may exchange information with resource manager 1203 to determine the local port mapping policy.

PMSP 204 applies the policy thus determined, and selects a suitable RNIC 105(*) from multiple RNICs within a single endnode, indicated by CP 201 in FIG. 14. In the present example, assume that a single IP address is advertised by AP 202, and that the address is used to aggregate IP addresses for RNIC 105(1) and RNIC 105(2). When CP 201 targets AP IP address 1.2.3.4 for port mapping, PMSP 204 selects a suitable one of the RNICs 105(*) whose IP addresses are aggregated into the target IP address. CP 201 then sets ApIPaddr 1109 in PMAccept message 302 to the corresponding IP address of the selected RNIC (e.g., RNIC 105(1) in FIG. 14), and replies to CP 201 with a PMAccept 302 message with the appropriate ApIPaddr 1109 to create a unique RDMA port association between the CP 201 and the AP 202.

FIG. 15 is a diagram showing an exemplary port mapping policy management scenario in which there are multiple RNICs 105(*) on different endnodes. Both of the endnodes shown in FIG. 15 are accepting peers 202, but selection of a suitable RNIC 105(*), as described herein, is applicable to either CPs 201 or APs 202 having multiple RNICs on different endnodes. Port mapping policy may be derived by the optimal endnode to launch an application instance or a function of QoS-based path selection, for example.

In FIG. 15, a single, aggregate IP address is advertised by AP 202. As shown in FIG. 15, endnode accepting peers 202(1) and 202(2) have an aggregate IP address (ApIPaddr 1109) of 1.2.3.4, and that RNICs 105(1)-105(4) have IP addresses of 1.2.3.123,1.2.3.124, 1.2.3.125, and 1.2.3.126, respectively. When accepting peer 201 receives a PMReq message 301, the associated PMSP 204 works with one or more policy management entities including local/centralized PMA 1202 and/or resource manager 1203, to determine the optimal endnode and RNIC 105(*). In the present example, RNIC 105(3), having IP address 1.2.3.125, and residing on AP 202(2), constitutes the optimal RNIC/endnode pair, as indicated by arrow 1501.

Where there are multiple RNICs on multiple connecting peers 201(*), the optimal CP 201 (not shown in FIG. 15) may be determined by an application running on a given endnode, and the combination of target service, service/system QoS, RNIC resources, etc., is used to determine the optimal RNIC. 105(*), as selected by policy management entities including PMA 204, PMA 1202 and/or resource manager 1203.

Transparent Service Migration

RNIC access to a fabric may fail because of a number of reasons including cable detachment or failure, switch failure, etc. If the failed RNIC 105(*) is multi-port and the other ports can access the CP 201/AP 202 of interest, then the fail-over can be contained within the RNIC if there are sufficient resources on the other ports of that RNIC. For example, in the FIG. 15 diagram, if RNIC 105(3) on accepting peer 202(2) were to fail, fail-over may be performed by migrating from RNIC 105(3) to RNIC 105(4) on the same endnode [e.g., connecting peer 202(2)], as indicated by dotted arrow 1502.

If there are insufficient resources to perform fail-over within a multi-port RNIC, then the RNIC state can be migrated to another RNIC on the same endnode. If local fail-over is not possible and the RNIC having insufficient resources is operational, then the RNIC state may be migrated to one or more spare RNICs, which are either idle/standby RNICs or active RNICs with available, non-conflicting resource states.

Target fail-over RNICs may be configured in an N+1 arrangement if there is a single standby RNIC for N active RNICs, or a configuration of N+M RNICs where there are multiple (M) standby or active/available RNICs. A standby RNIC may be a multi-port RNIC whose additional ports are not active and thus can be used without collision with the rest of the RNICs. In this case, all RNICs may be active, but not all ports on all RNICs are active.

Fail-over between endnodes is also illustrated in the FIG. 15 example, wherein RNIC 105(3) on accepting peer 202(2) is initially targeted by CP 201, as indicated by arrow 1501. In the present example, failure of the initial target RNIC 105(3) causes migration of the RNIC from AP 202(2) to AP 202(1) on a different endnode, which allows CP 201 to target RNIC 105(1) on AP 202(1), as indicated by dotted arrow 1503. Fail-over between endnodes requires the application/session state to be migrated, in addition to migration of the RNIC. Applications may be transparently restarted on target fail-over endnode by using application state to replay outstanding operations prior to failure such that the end user sees minimal service down time.

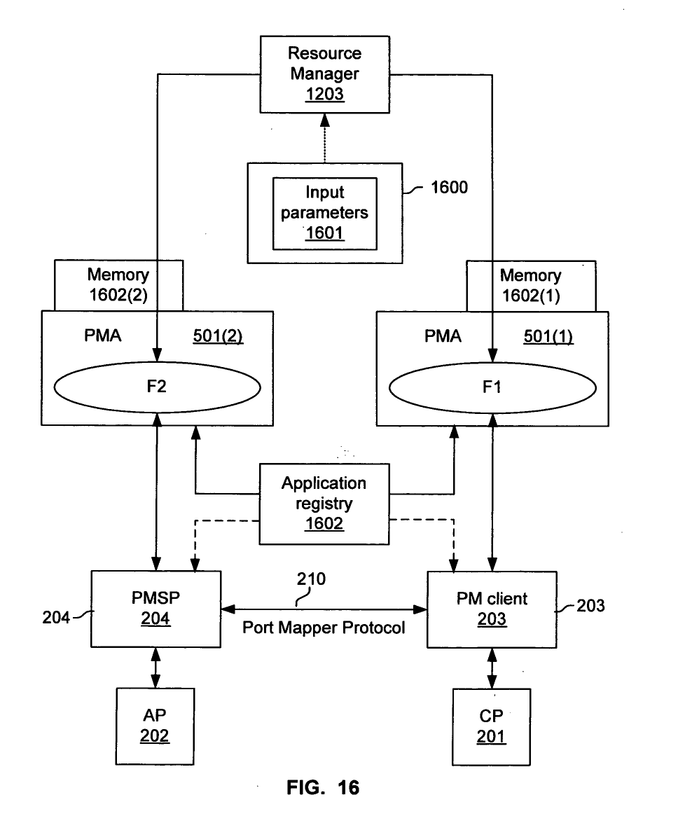

FIG. 16 is a diagram showing an exemplary a set of policy management functions, F1 and F2, associated with each of the expected communicating endnodes, i.e., connecting peer 201 and accepting peer 202. Function F1 is the policy management function for the PM client, and function F2 is the policy management function for the PMSP 204 associated with AP 202. Functions F1 and F2 are implemented via respective policy management agents 501(1) and 501(2), which implement port mapping policy for PM client 203 and PM service provider 204, respectively. In an exemplary embodiment, each PMA 501(*) is capable of standalone operation, but is also able to accept input from external resource management entities, such as a resource manager 1203, where additional intelligence or control is required. In the embodiment of FIG. 16, input parameters 1601, including system data and policy rules, are stored in parameter storage 1600, accessible by resource manager 1203. In standalone operation, where a PMA 501(*) implements policy management without input from an external policy management source, input parameters 1601 may be stored in memory 1602(*) accessible to the PMA 501(*), either locally or remotely.

An AP 202 or CP 201 can use input parameter information in conjunction with a PMA 501(*) to implement port mapping policy. The CP 201 uses input parameter information in much the same way as an AP 202, e.g., to identify whether the service should be accelerated or not, what resources to use (endnode, RNIC, etc), the number of instances to accelerate, whether to allow the PM to cache/reserve resources, and the like. Examples of input parameters 1601 that may be used for either side of the communication channel (i.e., parameters that are applicable to either a connecting peer 201 or an accepting peer 202), include:
the number of communication devices, e.g., RNICs;
application/service attributes and the ability to support them on a given endnode/device. For example, creating a distributed database session may require a different level of resources (e.g., CPU, memory, I/O) than a web server session. Information relating to a particular service may be used to determine how certain resources should be assigned, and also to determine priorities of execution, location of the service (e.g., the endnode and device);
the current workload on each endnode and endnode device;
whether a service requires transparent high availability services, e.g., transparent fail-over between two or more devices, where resource rebalancing upon fail-over is performed as a function of resource availability; and
the bandwidth of the device links and expected resource requirements.

The input parameters 1601 for each function F1/F2 are attributes determined by port mapping management policies, as well as the service data rate for the current type of session. Input parameters 1601 may also support permanent or long-term caching of port mapping parameters to allow high-speed connection establishment to be used. It is to be noted that the input parameters described above are examples and input parameters that may be used with the present system are not limited to those specifically described herein.

Function F1 (for PM client 203/CP 201) and/or function F2 (for PMSP 204/AP 202) is normally implemented by the corresponding PMA 501(*), using a set of policy management input parameters 1601, including policy rules, provided, for example, by resource manager 1203. Each input parameter 1601 can be a simple value, for example, the amount of memory available indicated in integer quantities. Alternatively, the input parameter can be variable and described by a function (hereinafter referred to as a ‘sub-function’, to distinguish over ‘primary’ functions F1 and F2) which takes into account factors including the application usage requirements for a given resource and the relative amount of a particular resource that may be applied to communication vs. application execution. Each policy rule is associated with a function (e.g., F1, for a CP), and may have one or more associated sub-functions, evaluated as part of function F1 or F2 to determine whether the applicable input parameters 1601 support port mapping.

The evaluation of functions F1 and/or F2, using policy rules and other input parameters 1601 as input, provides an indication of the change in state for the impacted services so that other requests or event thresholds may be updated to reflect the target service's current state. The new target service state may also trigger other events such as when resources become constrained and a policy indicates that the workload should be rebalanced. Thus, a PMA may help perform transparent service migration that is not caused by network component failure, and may also return IP-differentiated services parameters, which may include the assignment of a given session to a particular scheduling ring, service rate, etc.

As indicated above, a PMA 501(*) may migrate services to different RNICs and thus potentially different endnodes by simply changing the IP address that is returned. This can be done as part of on-going load balancing or in response to excessive load detection. The PMA may also assign sessions to scheduling rings or the like to change the amount of resources it is able to consume to reduce load and better support existing or new services in compliance with SLA requirements.

Policy rules may be constructed from various system resource and requirement aspects including those within an endnode, the associated fabric, and/or the application. System aspects that may be considered in formulating policy rules include:
RNIC capacity to support the number of connections that the target service requires. Each connection is associated with a given service but an application may require multiple connections in order to meet a service level objective in which an application will be operational at a specified performance level a given percentage of the time. Policy rule implementation can determine whether to support a particular service or to reserve a number of connections for the service so that it will always be able to operate at a given performance level. Policy rules can be used to assign some connection contexts to be persistently held in the RNIC so that they are resident and thus do not suffer latency when being accessed.
Memory mapping resources. These can be limited or may, optionally, be cached. PMA can determine how much memory mapping resources are required and whether the service can be supported or not.
QoS resources such as scheduling rings, the number of connections being serviced on a given scheduling ring, and the arbitration rate (both within the ring and between scheduling rings, since different priority connections will typically be segregated onto different scheduling rings). A PMA can determine whether adding a new connection is possible without negatively impacting other connections, while making sure the new connection will meet its SLA requirements.
Bandwidth requirements for the service. An RNIC selected for port mapping must have the associated bandwidth per port to meet the service needs. A related consideration is how much of the available bandwidth is currently consumed by other connections/services.
If an RNIC is multi-port, then a determination must be made as to which port should be used, based on various attributes such as bandwidth and latency.
If an RNIC is attached via a local I/O technology such as PCI-X or PCI Express, the associated bandwidth and operational characteristics of that I/O should be considered (i.e., the efficiency of the link and whether it delivers the required performance for the device).
The endnode memory bandwidth available for a service and service rate are also important aspects. A service may have low CPU consumption but still consume large amounts of memory (and I/O bandwidth if I/O attached) which can interfere with other services on the endnode.
If there are multiple RNICs on a given endnode, a PMA can assess the state of each RNIC (by tracking what is running and where) to determine optimal new service placement. The PMA may also track the state of each endnode. Each service may impact an endnode differently. Middleware may be optionally employed to track the state of each endnode, by, for example, tracking the number of service transactions occurring per unit of time. If the transaction rate falls below a given level, then the endnode may be overloaded, and load balancing may be effected by migrating services to other endnodes, reducing lower priority services' scheduling rates, or noting the situation and insuring no new services are initiated until the overload is relieved. Other related policies may simply indicate that each RNIC can support N instances of a given service or M different services, using load balancing techniques to assign new connections appropriately.

As an example of a policy rule, consider a rule ‘R1’ that deals with bandwidth requirements for the requested service. Such a rule may have an English-language description such as “Map the port (to RNIC) only if the RNIC has the associated bandwidth per port to meet the service needs”. For rule R1, there are three associated input parameters:
x1=Bandwidth requirements for the service
x2=Bandwidth of RNIC to be mapped
x3=Bandwidth currently consumed by RNIC(N) for other connections/services

Each input parameter 1601 may have an associated sub-function that determines whether or not a policy rule indicates that a port can be mapped. For example, a valid mapped port may be determined by evaluation of the function:
F1=F(X)+G(Y)+H(Z)+
where the functions F(X), G(Y), H(Z) . . . are sub-functions, and X, Y, and Z are input parameters 1601 (including policy rules), and each sub-function is an examination of whether a related parameter or rule is able to support the requested port mapping service. In the present example, the results of the evaluated sub-functions are combined via a logical OR operation such that if any sub-function indicates that a port should be mapped, then a look-up function can be used to find an available port to return to via the port mapper wire protocol.

Functions F1/F2 may take as input a wide range of input parameters 1601 including endnode type, endnode resource, RNIC types/resources, application attributes (type, priority, etc.), real-time resource/load on an RNIC, endnode, or the attached network, and so forth. A function (F1 or F2) returns the best-fit CP/AP, RNIC, port mapping, etc. Each function F1/F2 is typically implemented by a PMA 501(*), but may be implemented by a PMSP 204 or a PM client 203 in an environment in which a PMA is not employed.

In order to determine the impact of a service on an endnode, the endnode needs to be able to determine what resources are required to operate at a given performance level. One solution uses an application registry 1602 to track service resource requirements. If such a registry or equivalent a priori knowledge is available, a policy management agent 501(*) can use information in the registry to examine the service identified in the port mapper request and determine whether the service should be accelerated or not. The registry 1602 may be a simple table of service ports to be accelerated. Alternatively, the registry 1602 may be more robust and provide the PMA with additional information such that the PMA can examine the current mix of services being executed and determine whether this new service instance can operate while continuing to meet any existing SLA requirements.

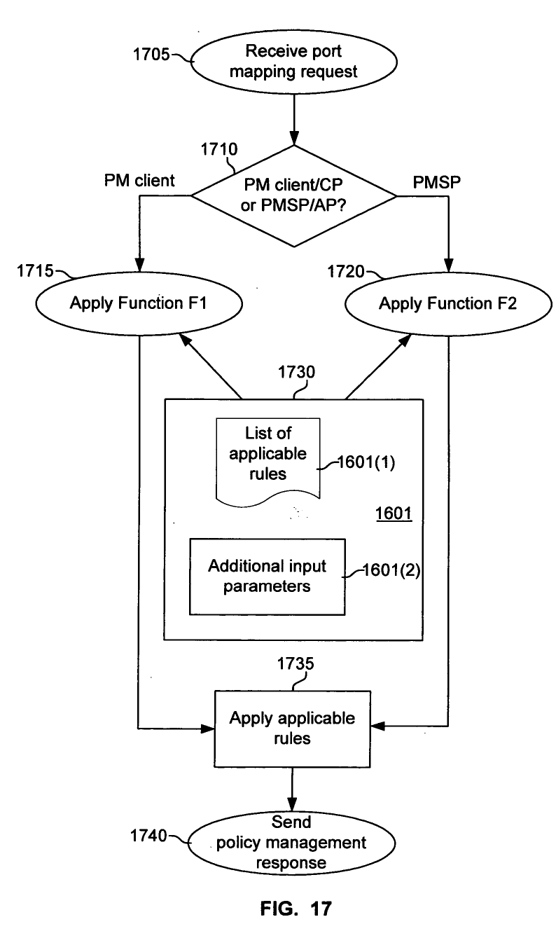

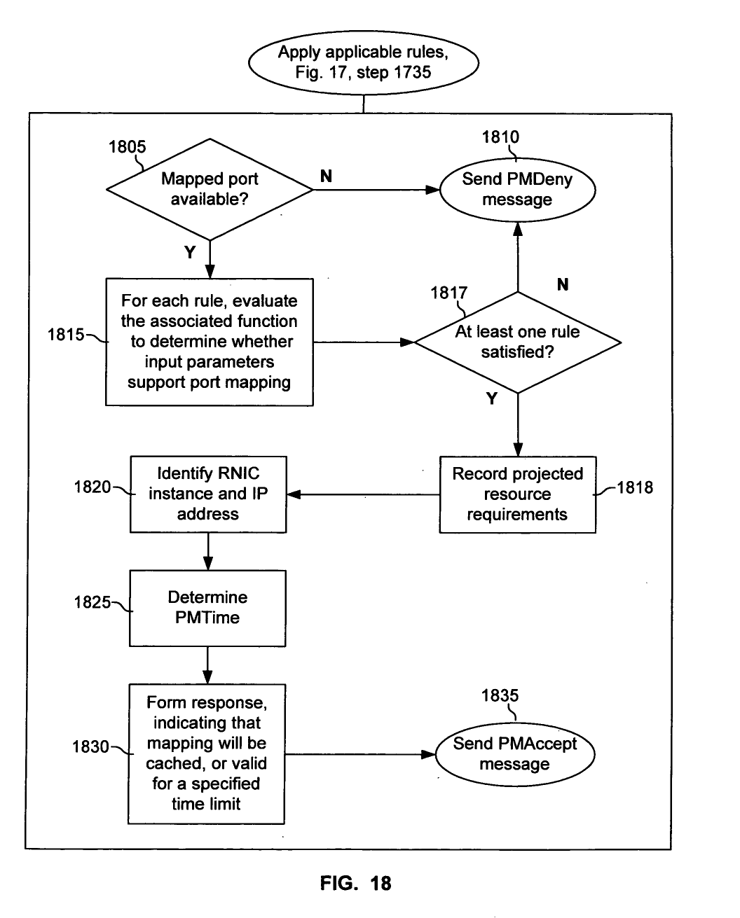

FIG. 17 is a flowchart showing an exemplary set of high-level steps performed in processing a port mapping request. As shown in FIG. 17, at step 1705, a port mapping request is received by a PMA 501(*). At step 1710, a determination is made as to whether the PMA is working on behalf of a PM client/CP or a PMSP/AP, and the corresponding step 1715 or step 1720 is then performed to implement the respective function F1 or F2. At step 1730, a list of the applicable rules 1601(1), and additional input parameters 1601(2), including sub-functions (or indicia of the locations of the sub-functions, if stored elsewhere), for the corresponding PMA 501(*) are then located from the input parameters 1601 stored in parameter storage 1600.

At step 1735, the applicable rules 1601(1) and other corresponding input parameters 1601(2) are applied to the appropriate function F1 or F2. After function F1 or F2 is evaluated, if it is determined that a valid port mapping exists, a response containing some or all of the following information is returned to the corresponding PMSP/AP or PM client/CP, at step 1740:
the target I/O device or communication channel to be used by CP 201, and the AP target IP addresses to be used, as each device/channel can have assigned multiple IP addresses; and
the target source and listen socket ports to be used for communication between CP 201 and AP 202.

FIG. 18 is a flowchart showing an exemplary set of steps performed to effect step 1735 of FIG. 17, wherein applicable rules 1601(1) and other corresponding input parameters 1601(2) are applied to the appropriate function F1 or F2. As shown in FIG. 18, at step 1805, a check is made to determine whether a mapped port is available. If no RNIC ports are presently available, then a PMDeny message is returned at step 1810, indicating that fact, and the processing of rules is terminated for the present port mapping request. Otherwise, at step 1815, for each applicable rule 1601(1), the associated sub-function is evaluated to determine whether input parameters support port mapping.

At step 1817, if at least one rule is satisfied, then processing of applicable rules continues at step 1818, otherwise, a PMDeny message is returned at step 1810. At step 1818, the resource requirements for the requested port mapping operation are stored to guide subsequent policy operations to avoid race failures. The specific RNIC instance and IP address to be used for the mapped port is then identified at step 1820. At step 1825, a value is determined for PMTime, indicating the period of time for which a mapping will be valid.

At step 1830, a response is created, indicating that mapping will either be cached, or valid for the time limit specified by PMTime, and a PMAcccept message is returned, indicating that the port mapping request has been accepted, at step 1835.

Exemplary function F1 pseudo-code for a PM client/CP is shown below:

Exemplary Pseudo-Code for PM Client/CP

If (target CP has one or more RNIC with resources available) then {

If (VALID(RNIC_id = F(Application(B/W requirements, Priority,

Memory map resources, number of connections required)) {

// Can attempt to establish a port mapping operation
CP_connection = SELECT_CONN(RNIC_id);
Record projected resource requirements;
Send port mapper request and proceed with port mapper

protocol

} else {

// Cannot proceed with protocol acceleration so use

normal connect establishment path
} else {

// Cannot proceed with protocol acceleration so use normal

connect establishment path

......

}

where F(Application(B/W reqs, Priority, Memory map resources, # of connections required) is a sub-function that accepts one or more parameters 1601 as input, wherein the input parameters may also be sub-functions.

A set of logic for function F2, similar to the above code for function F1, is performed by the PMSP/AP, as shown below:

Exemplary Pseudo-Code for a PMSP/AP

If (a potential target AP exists with one or more RNIC resources
available) then {

if (VALID(RNIC_id = F(Application(input parameters)) {

// Can attempt to establish a port mapping operation
Returned_AP_IP_addr = SELECT_AP_IP(port mapper

request IP address);

AP_RNIC = SELECT_AP_RNIC(Returned_AP_IP_addr);
Record projected resource requirements;
Send port mapper response and proceed with port

protocol;

} else {

// Cannot proceed with protocol acceleration so use

normal connect establishment path

.....

} else {

// Cannot proceed with protocol acceleration so use normal

connect establishment path

......

}

In an alternative embodiment, functions F1 and F2 evaluate the applicable input parameters 1601, and rather than evaluating a logical expression, the functions simply perform their appropriate calculations as well as the mapping and return the port directly.

Port mapping policy management may be implemented in the present system either as local-only or a global-only, or a hybrid of both, to allow benefits of central management while enabling local optimizations, for example, where a local hot-plug event may change available resources and not require a central policy management entity to react to the event. Although policy management may be implemented in a variety of ways, the implementation thereof can be expedited with a message-passing interface to allow policy management functionality to be distributed across multiple endnodes, and to re-use existing management infrastructures.

Certain changes may be made in the present system without departing from the scope thereof. It is to be noted that all matter contained in the above description or shown in the accompanying drawings is to be interpreted as illustrative and not in a limiting sense. For example, the system configurations shown in FIGS. 2 and 5-16 may be constructed to include components other than those shown therein, and the components may be arranged in other configurations. The elements and steps shown in FIGS. 3A, 3B, 4, 17, and 18 may also be modified in accordance with the methods described herein, without departing from the spirit of the system thus described.

What is claimed is:

1. A system for mapping a target service port, specified by an application, to an enhanced service port enabled for an application-transparent communication protocol, in a network including a plurality of endnodes, wherein at least one of the service ports within the endnodes includes a transparent protocol-capable device enabled for the application-transparent communication protocol, the system comprising:
receiving, at one of the endnodes, a port mapping request, initiated by the application, running on another of the endnodes, specifying the target service port and a target service accessible therefrom;
accessing a set of input parameters describing characteristics of the endnode on which the target service is running; and
providing output data, based on said characteristics, indicating the transparent protocol-capable device that can be used to access the target service, to thereby enable mapping of the target service port to the enhanced service port associated with the transparent protocol-capable device.

2. The system of claim 1, wherein a port mapper service provider, functioning as a server, and a port mapper client communicate using a port mapper protocol to enable a connecting peer, via the port mapper client, to negotiate with the port mapper service provider to translate the target service port specified by the application into the enhanced service port.

3. The system of claim 1, wherein the transparent communication protocol is RDMA and the transparent protocol-capable device is an RNIC.

4. The system of claim 1, wherein the set of input parameters includes a list of policy rules describing aspects of system resources and requirements within the endnodes, including requirements of the application.

5. A system for mapping a target service port, specified by an application, to an RDMA-enabled service port addressable by an RDMA communication protocol transparent to the application, in a network including a plurality of endnodes, wherein at least one of the service ports within the endnodes includes an RDMA-enabled device, the system comprising the steps of:
receiving, at one of the endnodes, a port mapping request, initiated by the application running on another of the endnodes, specifying the target service port and a target service accessible therefrom;
accessing a set of input parameters describing characteristics of the endnode on which the target service is running; and
providing output data, based on said characteristics, indicating the RDMA-enabled device that can be used to access the target service, to thereby enable mapping of the target service port to the RDMA-enabled service port associated with the RDMA-enabled device.

6. The system of claim 5, wherein a port mapper service provider, functioning as a server, and a port mapper client communicate using a port mapper protocol to enable a connecting peer, via the port mapper client, to negotiate with the port mapper service provider to translate the target service port specified by the application into the RDMA-enabled service port.

7. The system of claim 5, wherein RDMA-enabled device is an RNIC.

8. The system of claim 5, wherein the characteristics of one of the endnodes comprise operational characteristics of the devices on the endnode.

9. The system of claim 5, wherein said input parameters include system data and policy rules describing aspects of system resources including requirements of the application.

10. The system of claim 9, wherein said policy rules are based on factors selected from the group of aspects consisting of RNIC capacity required to support the number of connections that the target service requires, memory mapping resources, quality of service resources, bandwidth requirements for the target service, and endnode memory bandwidth available for the target service.

11. The system of claim 9, wherein said policy rules include system aspects comprising:
examining the target service to determine the number that can be supported per endnode;
examining the connecting peer for a given service to determine the number of concurrent mapped sessions for a given connecting peer; and
examining the AP to ensure that sufficient resources are available for a given accepting peer.

12. A system for mapping of an non-RDMA-enabled port, specified by an application, to an RDMA-enabled port in a network including a plurality of endnodes, the system comprising:
a connecting peer, located on a first one of the endnodes, requesting a target service via a service port;
an accepting peer, located on a second one of the endnodes, on which the service port is also located;
a set of policy rules describing aspects of system resources and requirements within the endnodes, including requirements of the application;
a port mapping service provider, functioning as a server on behalf of the accepting peer; and
a port mapper client, communicating with the port mapper service provider on behalf of the connecting peer and implementing port mapping policy as indicated by the policy rules;
wherein the connecting peer negotiates with the port mapping service provider, via the port mapper client, to perform a port mapping function by translating the service port, specified by the application for a target service, into an associated RDMA service port to be used by the accepting peer to access the target service.

13. The system of claim 12, wherein the port mapping service provider is co-located with the accepting peer.

14. The system of claim 12, wherein the port mapping service provider is centralized with respect to a plurality of potential accepting peers and connecting peers.

15. The system of claim 12, including a plurality of accepting peers, and further comprising a plurality of local policy management agents;
wherein the port mapping service provider and one of the local policy management agents are co-located with the accepting peer; and
wherein the local policy management agent for the accepting peer communicates with the port mapping service provider to implement port mapping policy to perform the port mapping function.

16. The system of claim 15, wherein another one of the local policy management agents communicates with the port mapper client to perform at least part of the port mapping function.

17. The system of claim 12, wherein the port mapping service provider is centralized using a centralized policy management agent that communicates with the port mapping service provider to implement port mapping policy to perform the port mapping function.

18. The system of claim 12, including a policy management agent communicating with the port mapping service provider to implement port mapping policy and to perform port mapping;
wherein the port mapping service provider interacts with the policy management agent to implement endnode or service-specific policies, and is associated with an accepting peer; and
wherein the port mapping service provider returns an RDMA address that the connecting peer may use to establish an RDMA-based connection with a specified accepting peer.

19. The system of claim 12, including an application registry containing information used to examine the service identified in a port mapping request and determine whether the service should be mapped.

20. The system of claim 19, wherein the registry is a table of potential service ports to be mapped.

21. The system of claim 12, wherein said policy rules include system aspects comprising at least one of the steps in the group of steps consisting of:
examining the target service to determine the number that can be supported per endnode;
examining the connecting peer for a given service to determine the number of concurrent mapped sessions for a given connecting peer; and
examining the AP to ensure that sufficient resources are available for a given accepting peer.

22. A system for mapping of an non-RDMA-enabled port to an RDMA-enabled port in a network including a plurality of endnodes, the system comprising:
a connecting peer, located on a first one of the endnodes, requesting a target service via a service port;
an accepting peer, located on a second one of the endnodes on which the service port is located;
a local port mapper client, communicating with the port mapper service provider using a port mapper protocol; and
a local policy management agent;
wherein the connecting peer contacts the port mapper client to request the port mapper client to map the service port for the accepting peer by translating the service port, specified by the application for the target service, into an associated RDMA service port to be used by the accepting peer to access the target service; and
wherein, if the port mapper client determines a valid port mapping configuration, the configuration is returned to the connecting peer.

23. A method for mapping of an non-RDMA-enabled port to an RDMA-enabled port in a network including a plurality of endnodes, an accepting peer, located on one of the endnodes, requesting a target service, and a connecting peer, located on a different one of the endnodes, providing access to the target service, the system comprising:
receiving a port mapping request from the connecting peer;
locating, from a set of stored input parameters, a list of applicable policy rules describing aspects of system resources and requirements within the endnodes and aspects related to the application;
applying the applicable policy rules to a policy management function;
wherein the policy management function, when evaluated, provides port mapping information including indicia of the target I/O device to be used by the connecting peer, the accepting peer target IP addresses to be used, and target source and listen socket ports to be used for communication, between the connecting peer and the accepting peer, for access to the target service by the accepting peer;
evaluating the port mapping function, using the policy rules as input;
and
if it is determined that a valid port mapping exists, then returning a response to the connecting peer including said port mapping information.

24. The method of claim 23, wherein said policy rules include system aspects comprising:
examining the target service to determine the number that can be supported per endnode;
examining the connecting peer for a given service to determine the number of concurrent mapped sessions for a given connecting peer; and
examining the AP to ensure that sufficient resources are available for a given accepting peer.

25. A system for mapping of an non-RDMA-enabled port to an RDMA-enabled port in a network including a plurality of endnodes, an accepting peer, located on one of the endnodes and requesting a target service, and a connecting peer, located on a different one of the endnodes and providing access to the target service, the system comprising:
sending a port mapping request, indicating the target service, from the accepting peer to the connecting peer;
locating, from a set of stored input parameters, a list of applicable rules and additional input parameters for the policy management assistant, in response to receipt of the port mapping request;
applying the applicable rules and additional input parameters to a policy management function;
when evaluation of the policy management function indicates that a valid port mapping exists, then returning a response to the connecting peer including the target I/O device to be used by the connecting peer, the accepting peer target IP addresses to be used for access of the target service by the accepting peer.

26. The system of claim 25, wherein the port mapping request is received and processed by a policy management assistant working on behalf of the connecting peer.

27. The system of claim 25, wherein the response includes the target source and listen socket ports to be used for communication between the connecting peer and the accepting peer.

28. A system for mapping of an non-RDMA-enabled port to an RDMA-enabled port in a network including a plurality of endnodes, an accepting peer, located on one of the endnodes, requesting a target service, and a connecting peer, located on a different one of the endnodes, providing access to the target service, the system comprising:
a stored set of input parameters, including policy rules describing aspects of system resources and requirements within the endnodes and related to the application;
a resource manager for determining application-specific resource requirements from the set of input parameters;
a policy management agent, coupled to the resource manager and to the connecting peer; and
a policy management function;
wherein the policy management function, when evaluated by the policy management agent, provides port mapping information including indicia of the target I/O device to be used by the connecting peer, the accepting peer target IP addresses to be used, and the target ports to be used for communication between the connecting peer and the accepting peer for access of the target service by the accepting peer.

29. The system of claim 28, wherein at least one of the input parameters has an associated sub-function that is evaluated to determine whether or not a policy rule indicates that a port can be mapped; and
wherein the evaluation of the sub-function indicates whether the associated input parameter can support the requested port mapping service.

30. The system of claim 28, including an application registry containing information used to examine the service identified in a port mapping request and determine whether the service should be mapped.

31. The system of claim 30, wherein the registry is a table of potential service ports to be mapped.

32. A system for mapping of an non-RDMA-enabled port to an RDMA-enabled port in a network including a plurality of endnodes, an accepting peer, located on one of the endnodes, requesting a target service, and a connecting peer, located on a different one of the endnodes, providing access to the target service, the system comprising:
means for storing a set of input parameters, including policy rules describing aspects of system resources and requirements within the endnodes and related to the application;
means for determining application-specific resource requirements from the set of input parameters;
means for policy management, coupled to the resource manager and to the connecting peer; and
a policy management function, evaluated by the policy management means, for providing port mapping information including indicia of the target I/O device to be used by the connecting peer, the accepting peer target IP addresses to be used, and the target ports to be used for communication between the connecting peer and the accepting peer for access of the target service by the accepting peer.
